(19) United States
(12) Patent Application Publication
(10) Pub. No.: US 2009/0273250 A1
(43) Pub. Date: Nov. 5, 2009

(54) ELECTRIC MOTOR, IN PARTICULAR FOR MOTOR VEHICLE WINDSHIELD WIPER DRIVE WITH IMPROVED SEATING FOR THE ARMATURE SHAFT BEARING

(75) Inventors: Mario Huesges, Buehlertal (DE); Detlef Lauk, Renchen (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,238

(22) PCT Filed: Jul. 12, 2007
(86) PCT No.: PCT/EP2007/057145

§ 371 Date: Dec. 17, 2008

(30) Foreign Application Priority Data
Sep. 8, 2006 (DE) 10 2006 042 340.2

(51) Int. Cl. H02K 5/16

(52) U.S. Cl. 310/90

(57) ABSTRACT

The invention relates to an electric motor (1), in particular for the windscreen wiper drive of a motor vehicle, comprising an armature shaft (10), which is mounted by means of at least one anti-friction bearing (11). Said bearing has an inner bearing ring (12), joined to the armature shaft (10) and also an outer bearing ring (13), held in a bearing seat, the latter consisting of a first half-shell (14) and a second half-shell (15), which are fitted together with their interiors facing one another to form a closed radially symmetrical bearing seat. The invention thus provides an electric motor (1) for the windscreen wiper drive of a motor vehicle with a simple seating for the anti-friction bearing (11) of the armature shaft (10).

### BACKGROUND OF THE INVENTION

The present invention relates to an electric motor, in particular for a windshield wiper drive of a motor vehicle.

Electric motors of the type mentioned above usually drive, via a worm, a transmission device which can be used, for example, to drive a windshield wiper system, a window lifter system, a seat adjustment system or the like. Such electric motors have different bearing arrangements which serve to support the armature shaft in both the radial and axial directions.

German laid-open patent application DE 199 26 171 A1 discloses an electric motor for a windshield wiper drive of a motor vehicle. Said windshield wiper drive comprises a bearing which is inserted in a bearing seat which is difficult to access. In this context, the bearing is secured axially in the bearing seat by means of a latching element. This makes it possible for the bearing which is fitted on to the armature shaft to be inserted with the armature into the bearing seat. The electric motor and the associated transmission housing are embodied in multiple parts so that the electric motor comprises a pole housing which is connected by flanges to the transmission housing. The bearing seat is formed from the transmission housing, and the difficulty in accessing the bearing seat is caused by the pot-shaped form within the closed transmission housing. The armature and the motor housing which is formed by the pole housing have to be inserted into the transmission housing by means of a complex joining method during which, apart from the connection of the motor housing to the transmission housing by means of screws or the like, at first only the latching element serves to produce the locked connection. Mounting is therefore difficult and dismounting is virtually impossible, only being possible at greater cost.

The German laid-open patent application 197 27 120 A1 discloses an electric motor for a windshield wiper drive of a motor vehicle having an electric motor which has an essentially pot-shaped pole housing in which an armature is arranged. A transmission housing which serves to hold transmission elements is attached to the pole housing. An armature shaft extends from the pole housing to the transmission housing and is mounted, on the one hand, in the pole housing and, on the other hand, in the transmission housing. It is also extremely costly to mount the individual components here since the armature firstly has to be inserted into the pole housing in order then to insert the bearing into the transmission housing. For this purpose, a securing clip is provided which axially secures the roller bearing in the transmission housing. The roller bearing is pressed into the bearing seat within the transmission housing and is surrounded by the transmission housing over its full circumference. To dismount the roller bearing it is necessary to release the form fit, which frequently involves increased dismounting work.

### SUMMARY OF THE INVENTION

The object of the present invention is therefore to provide an electric motor for a windshield wiper drive of a motor vehicle which permits the roller bearing of the armature shaft to be seated easily.

The object is achieved on the basis of an electric motor having an armature shaft which is mounted by means of at least one roller bearing which has a bearing inner ring which is arranged on the armature shaft, and a bearing outer ring which is held in a bearing seat, characterized in that the bearing seat is formed from a first half shell and a second half shell which are connected to one another with their shell interiors facing one another so as to form a closed radially symmetrical bearing seat.

The invention includes the technical teaching that the bearing seat is formed from a first half shell and a second half shell which are arranged with their shell interiors facing one another so as to form a closed radially symmetrical bearing seat.

The invention is based here on the idea of using two half shells to form a bearing seat, which half shells form a radially symmetrically bearing seat when they are arranged facing one another. During the mounting process, the armature can easily be inserted into the first half shell with the roller bearing attached to the bearing shaft, in which case the second half shell can easily be inserted in order to form the radially symmetrical bearing seat. In the mounted arrangement, the half shells form a passage for the armature shaft which is larger than the armature shaft itself.

Depending on requirements, a sealing element such as a felt ring or a lip seal for forming a seal against impurities and the like can be attached in advance to the armature shaft in order to be held and received by the half shells during operation. The half shells each have a circular section of the bearing seat of 180°, with the result that the roller bearing can be inserted into the first and second half shells without the need for force.

Advantageously, the electric motor is arranged on a transmission housing in which the first half shell is formed from a body section of the transmission housing. The transmission housing is therefore formed in one piece and in a materially uniform fashion with the first half shell, with the result that the latter merely emerges from the transmission housing and is arranged on it in the form of a body section. The transmission housing can be manufactured by means of an injection molding method so that the geometric configuration of the first half shell as an element which is integrally formed on to the transmission housing can easily be made possible. The junction between the transmission housing and the first half shell therefore forms a mechanical connection between the electric motor and the transmission housing.

Corresponding transmission means which drives, for example, a worm wheel via a worm which is arranged on the armature shaft of the electric motor can be arranged in the transmission housing. The seat of the roller bearing can therefore form a mechanical interface between the electric motor and the transmission housing.

According to a further exemplary embodiment of the invention it is provided for the half shells to comprise a front and a rear shoulder in order to support the armature shaft axially in the bearing seat by means of the roller bearing. The roller bearing provides the possibility not only of providing radial guidance but also of absorbing axial forces, with the result that possible stop mushrooms, stop springs or other arrangements for absorbing axial forces within the armature shaft bearing can be dispensed with.

The shoulders of the half shells can at least engage around the bearing outer ring here, in which case the bearing inner ring can also carry out a rotation at least adjacent to the shoulders of the half shells. In this context it is to be noted that the bearing inner ring rotates only within the shoulders without being in contact with them or being involved in a positively locking connection with the shoulders. The shoulders form a passage of the armature shaft which, for example, is slightly larger than the armature shaft itself.

It is therefore possible to provide grease lubrication of the roller bearing. The roller bearing can be embodied, for example, as an open roller bearing in order to obtain possible grease supplies in or in the vicinity of the bearing.

If an axial force is applied to the armature shaft, said axial force is transferred into the half shells via the bearing inner ring, the roller bearing and the bearing outer ring. The division of the half shells makes it possible to secure the bearing outer ring axially without large technical expenditure and without the addition of securing rings such as, for example, a snap ring.

According to a further exemplary embodiment of the invention, the electric motor comprises a pot-shaped or tubular pole housing which surrounds the first and second half shells at least in certain sections over their outer circumference. The pole housing forms the housing of the electric motor and is conventionally composed of a soft iron sleeve. Said pole housing may have a tubular section into which the half shells which are placed one on top of the other can be inserted. The half shells can either be covered in certain sections by the pole housing or advantageously the half shells are inserted completely, i.e. over their entire width, into the pole housing.

Grooves which run around the circumference may also extend over the outer circumference, in which case the pole housing can be roller-burnished in the region of the grooves in order to connect the half shells to the pole housing in a positively locking fashion. The half shells can be secured in the pole housing by the roller-burnishing, in which case the material of the pole housing is at least partially pressed into the grooves in the half shells. This results in a positively locking connection between the pole housing and the half shells.

In addition it is possible, as an alternative to the roller-burnishing of the pole housing, to caulk half shells to the pole housing by making plastic changes to the shape of the pole housing distributed over the circumference in such a way that a positively locking connection to the half shells can also be made.

The roller-burnishing can either be made over the outer circumference of the pole housing, in which case it is also possible to bend over or flange the pole tube in the end region, with the result that the flange edge which is formed surrounds the half shells and therefore secures them within the pole housing. Forming a stop within the pole housing also makes it possible to limit the insertion of the half shells into the pole housing, with the result that the flange edge braces the half shells against the stop. In the case of screwing of the half shells in the pole housing, for example through at least one radially fed screw, it is also possible to secure the half shells within the pole housing, in which case dismounting is simplified when such connecting means are applied.

According to a further advantageous exemplary embodiment of the invention, the first half shell or the transmission housing and/or the second half shell are manufactured from a plastic material. By means of such a selection of material it is possible to manufacture the components easily by means of injection molding. In addition, it is possible to use the resilience or the elastic behavior of a plastic material to attach the roller bearing without play in a simple way within the half shells. The bearing seat which is formed by the half shells which are attached to one another so that they face one another has, for this purpose, a diameter which is selected to be slightly smaller than the bearing outer ring of the roller bearing, with the result that a form fit can be provided. The half shells can therefore be clamped to the roller bearing and connected in the pole housing.

The total arrangement comprising the roller bearing, the first and second half shells and the pole housing can be formed without play in this way, in which case the resilience of the plastic material of the half shells permits a defined bearing prestress to be applied. The plastic material may be from the group of polycarbonates, polystyrenes, acrylonitrile butadiene styrenes, the polymethyl metacrylates or from a similar group.

A further advantageous exemplary embodiment of the invention provides for the roller bearing to be embodied in the manner of a ball bearing by means of which, in addition to radial forces, it is also possible to absorb axial forces. In this context, it is possible to use conventional deep groove ball bearings in which other types of bearing, for example a shoulder ball bearing, also constitute a possible embodiment. The bearing should advantageously permit axial forces to be absorbed in order to conduct the axial force inserted by the worm drive in the armature shaft into the arrangement of the half shells and of the pole housing.

The armature shaft is advantageously mounted on at least one further side facing away from the transmission housing, by means of a sliding bearing. The sliding bearing is accommodated here in a disk-shaped bearing shield which is surrounded by the pole housing at least in certain sections over its outer circumference and is connected to the pole housing in a positively locking fashion by means of a groove. The bearing shield can be attached within the pole housing in the same way as the first and second half shells. The said pole housing accommodates the sliding bearing within a bore, in which case the sliding bearing can be pressed, for example, into the end shield.

At the end side, the end shield can advantageously be closed off in order to prevent the ingress of soiling. Furthermore, a space to be filled with bearing grease can be provided. Owing to the simple arrangement of the end shield, it can be embodied in one part, in which case the positively locking attachment of the end shield within the hollow pipe can be made in the same way as the arrangement of the first and second half shells. The sliding bearing serves only to accommodate radial forces and can be considered to be a loose bearing in terms of the overall bearing arrangement.

In addition, it is also possible to mount the armature shaft on the worm, in which case the bearing is inserted within the transmission housing. There is therefore the possibility of supporting the shaft also with three bearings, only one of which has to be embodied as a fixed bearing which is formed by the roller bearing.

Further measures which improve the invention will be presented below in more detail together with the description of a preferred exemplary embodiment of the invention with reference to the single FIGURE.

### BRIEF DESCRIPTION OF THE DRAWINGS

FIG. 1 shows a schematic cross-sectional illustration of an electric motor for a windshield wiper drive having a bearing arrangement according to the present invention.

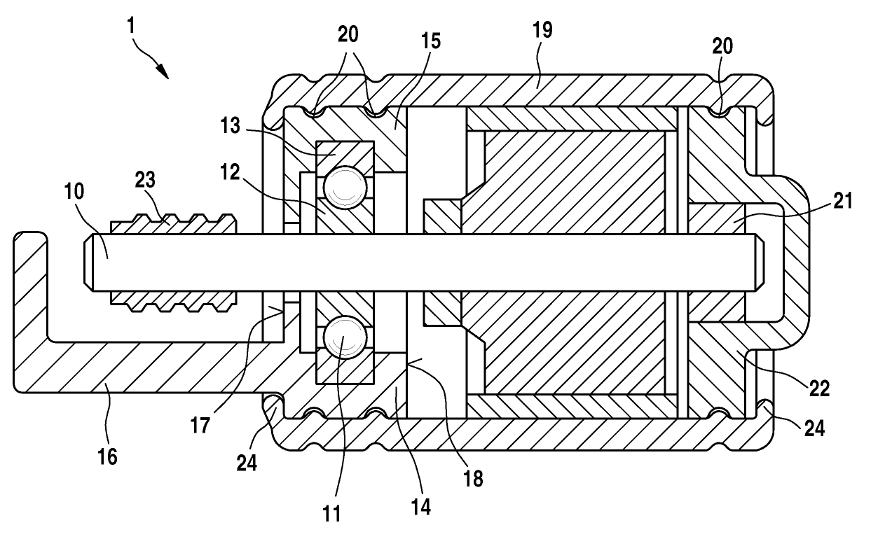

### DETAILED DESCRIPTION

The electric motor 1 illustrated in the FIGURE is composed of an armature shaft 10 which is rotatably mounted within a pole housing 19 by means of a roller bearing 11 and a sliding bearing 21. The roller bearing 11 is composed, in addition to the roller bodies, of a bearing inner ring 12 and a bearing outer ring 13. The bearing inner ring 12 is pressed onto the armature shaft 10 or secured axially by means of securing elements. The bearing outer ring 13 is located in a bearing seat, in which case the bearing seat itself is formed by a first half shell 14 and a second half shell 15.

The half shells 14 and 15 extend at an angle of, in each case, 180° around the bearing outer ring 13. The first half shell 14 and the second half shell 15 produce a radially symmetrical bearing seat in which the half shells 14 and 15 surround the roller bearing 11 over its full circumference. The first half shell 14 is formed from a body section of a transmission housing 16, and the transmission housing 16 therefore merges with uniform material, i.e. integrally, into the first half shell 14. As a result, the first half shell 14 forms a mechanical coupling of the electric motor 1 to the transmission housing 16 of the windshield wiper drive.

The roller bearing 11 is embodied as a ball bearing which can absorb both radial forces and axial forces. An axial force is applied to the armature shaft 10 via a worm 23 so that said axial force is transferred into the first and second half shells 14 and 15 via the bearing inner ring 12, the roller body and the bearing outer ring 13. The bearing shells 14 and 15 are inserted into a pole housing 19 and caulked therein in an axially secure fashion by means of roller-burnishing.

The roller-burnishing is carried out by means of grooves 20, with the first half shell 14 and the second half shell 15 each having a groove which runs around in a closed fashion on the respective outer side. The roller-burnishing is carried out in each case by means of the groove 20, with the result that the material of the pole housing 19 is pressed at least partially into the grooves 20. In addition, the pole housing 19 is provided with a flange edge 24 which also forms an axial securing means for the first and second half shell 14 and 15 within the pole housing 19.

In order to transfer the axial forces from the bearing outer ring 13 into the first and second half shells 14 and 15, the latter have a front shoulder 17 and a rear shoulder 18 which extends in the radial direction at least over the bearing outer ring 13. The bearing outer ring 13 is therefore held in an axially secured fashion between the front shoulder 17 and the rear shoulder 18, with the result that said bearing outer ring 13 is held in an axially secured fashion in both directions.

According to the illustration in the FIGURE, the front shoulder 17 and rear shoulder 18 are embodied in the diameter in such a way that they extend radially to just before the armature shaft 10 in order to house the roller bearing 11. The side of the armature shaft which faces away from the transmission is rotatably mounted by means of a sliding bearing 21 which is arranged inside a bearing shield 22. The end shield 22 also has on its outer side a groove 20 into which the material of the pole housing 19 is at least partially pressed by roller-burnishing. The bearing shield 22 is therefore secured within the pole housing 19. According to the illustration, the end shield 22 is embodied in the manner of a continuous disk in order to close off the sliding bearing 21 from the outside of the electric motor 1.

The invention is not restricted in its embodiment to the preferred exemplary embodiment specified above. Instead, a number of variants are conceivable which make use of the illustrated solution even in embodiments which are fundamentally different in nature. For example, it is possible to provide a respective seat for the carbon brushes which interact with the collector of the armature packet of the electric motor in the first half shell and the second half shell. In this context, formed-on elements for accommodating a device may be provided on the side of the rear shoulder, which elements comprise, for example, what are referred to as carbon shafts or other receptacles for carbon for pressing in a spring-loaded fashion against the collector of the armature packet. In addition, annular seals, lip seals or felt seals (not illustrated in the FIGURE) may be provided within the front and rear shoulder of the first and second bearing shells, and these provide a simple way of sealing the interior of the electric motor 1 with respect to the surroundings.

1. An electric motor (1), having an armature shaft (10) which is mounted by means of at least one roller bearing (11) which has a bearing inner ring (12) which is arranged on the armature shaft (10), and a bearing outer ring (13) which is held in a bearing seat, characterized in that the bearing seat is formed from a first half shell (14) and a second half shell (15) which are connected to one another with their shell interiors facing one another so as to form a closed radially symmetrical bearing seat.

2. The electric motor (1) as claimed in claim 1, characterized in that the electric motor (1) is arranged on a transmission housing (16), and the first half shell (14) is formed from a body section of the transmission housing (16).

3. The electric motor (1) as claimed in claim 1, characterized in that the half shells (14, 15) comprise a front and a rear shoulder (17, 18) in order to support the armature shaft (10) axially in the bearing seat by means of the roller bearing (11).

4. The electric motor (1) as claimed in claim 1, characterized in that the electric motor (1) comprises a pot-shaped or tubular pole housing (19) which surrounds the first and second half shells (14, 15) at least in certain sections over their outer circumference.

5. The electric motor (1) as claimed in claim 4, characterized in that the half shells (14, 15) have at least one circumferential groove (20) in the outer circumference, wherein the pole housing (19) is roller-burnished in the region of the groove (20) in order to connect the half shells (14, 15) to the pole housing (19) in a positively locking fashion.

6. The electric motor (1) as claimed in claim 1, characterized in that the transmission housing (16) and therefore the first half shell (14) and/or the second half shell (15) are manufactured from a plastic material.

7. The electric motor (1) as claimed in claim 1, characterized in that the bearing seat which is formed by the half shells (14, 15) which are placed one on top of the other has a diameter which is slightly smaller than the bearing outer ring (13) of the roller bearing (11) in order to provide a form fit.

8. The electric motor (1) as claimed in claim 1, characterized in that the armature shaft (10) is mounted on at least one further side facing away from the transmission housing (16), by means of a sliding bearing (21).

9. The electric motor (1) as claimed in claim 8, characterized in that the sliding bearing (21) is accommodated in a disk-shaped bearing shield (22) which is surrounded by the pole housing (19) at least in certain sections over its outer circumference and is connected to the pole housing (19) in a positively locking fashion by means of a groove (20).

10. A rear windshield wiper system, in particular for a motor vehicle, having an electric motor (1) having an armature shaft (10) which is mounted by means of at least one roller bearing (11) which has a bearing inner ring (12) which is arranged on the armature shaft (10), and a bearing outer ring (13) which is held in a bearing seat, characterized in that the bearing seat is formed from a first half shell (14) and a second half shell (15) which are connected to one another with their shell interiors facing one another so as to form a closed radially symmetrical bearing seat.

11. A wiper system (1) as claimed in claim 10, characterized in that the electric motor (1) is arranged on a transmission housing (16), and the first half shell (14) is formed from a body section of the transmission housing (16).

12. A wiper system (1) as claimed in claim 11, characterized in that the half shells (14, 15) comprise a front and a rear shoulder (17, 18) in order to support the armature shaft (10) axially in the bearing seat by means of the roller bearing (11).

13. A wiper system (1) as claimed in claim 12, characterized in that the electric motor (1) comprises a pot-shaped or tubular pole housing (19) which surrounds the first and second half shells (14, 15) at least in certain sections over their outer circumference.

14. A wiper system (1) as claimed in claim 13, characterized in that the half shells (14, 15) have at least one circumferential groove (20) in the outer circumference, wherein the pole housing (19) is roller-burnished in the region of the groove (20) in order to connect the half shells (14, 15) to the pole housing (19) in a positively locking fashion.

15. A wiper system (1) as claimed in claim 14, characterized in that the transmission housing (16) and therefore the first half shell (14) and/or the second half shell (15) are manufactured from a plastic material.

16. A wiper system (1) as claimed in claim 15, characterized in that the bearing seat which is formed by the half shells (14, 15) which are placed one on top of the other has a diameter which is slightly smaller than the bearing outer ring (13) of the roller bearing (11) in order to provide a form fit.

17. A wiper system (1) as claimed in claim 16, characterized in that the armature shaft (10) is mounted on at least one further side facing away from the transmission housing (16), by means of a sliding bearing (21).

18. A wiper system (1) as claimed in claim 17, characterized in that the sliding bearing (21) is accommodated in a disk-shaped bearing shield (22) which is surrounded by the pole housing (19) at least in certain sections over its outer circumference and is connected to the pole housing (19) in a positively locking fashion by means of a groove (20).
